(19) United States
(12) Patent Application Publication
(10) Pub. No.: US 2007/0101877 A1
(43) Pub. Date: May 10, 2007

(54) Dual printing mask for screen printing

(76) Inventors: Joon-Mo Seo, Gyeonggi-do (KR); Byoung-Un Kang, Seoul (KR); Kyung-Tae Wi, Gyeonggi-do (KR); Jae-Hoon Kim, Seoul (KR); Tae-Hyun Sung, Seoul (KR); Goo-Yun Chung, Seoul (KR); Seong-Hwan Jang, Gyeonggi-do (KR); Tae-Kyu Im, Seoul (KR)

Correspondence Address: JONES DAY, 222 EAST 41ST ST, NEW YORK, NY, 10017, US

(21) Appl. No.: 11/593,186

(22) Filed: Nov. 3, 2006

(30) Foreign Application Priority Data
Nov. 8, 2005 (KR) KR10-2005-0106660

(51) Int. Cl. B05C 17/06

(52) U.S. Cl. 101/127

(57) ABSTRACT

A dual printing mask is used for coating a die adhering paste of a predetermined pattern on a substrate uniformly during a semiconductor packaging process. This dual printing mask includes a metal mask layer having a predetermined pattern of openings so as to receive a paste for adhering a semiconductor die onto a substrate, and a mesh layer integrally attached on the metal mask layer.

### BACKGROUND OF THE INVENTION

1. Field of the Invention

The present invention relates to a screen printing method for coating a paste on a substrate for the purpose of adherence of a semiconductor die, and more particularly to a screen printing method using a dual printing mask including a metal mask and a mesh.

2. Description of the Related Art

Generally, when manufacturing a semiconductor device, a die adhering process is used for adhering a semiconductor die to a substrate such as a lead frame or PCB. For the die adhering process, conductive liquid adhesive such as silver-epoxy, silver-glass or solder and non-conductive liquid adhesive free from conductive material are frequently used as an adhesive means. This liquid adhesive is dropped on a substrate such as a lead frame, and then a semiconductor die is placed thereon and then compressed, which is generally called a dispensing method. In other cases, a paste is coated on a substrate to have a certain shape, and then a die is adhered on the coated pasted, which is called a screen printing method, proposed recently.

FIG. 1 is a schematic view showing a conventional screen printing method. Referring to FIG. 1, a printing mask 20 is arranged on a substrate 10, and then a squeegee 40 is moved to coat an adhesive paste 30 on the substrate 10.

However, since the squeegee 40 is moved in contact with the paste 30 in the above method, it is difficult to control a thickness of the paste 30 to be coasted uniformly. Thus, after the screen printing process, an edge portion of the paste 30 is relatively thicker than a center portion, and the paste 30 moves up along an end portion of the moving squeegee 40. In addition, since the thickness of the paste 30 is not easily controlled and a deviation of thickness of the coated paste 30 is great, there arise melt flow and voids even in a following process of adhering a die (not shown).

### SUMMARY OF THE INVENTION

The present invention is designed to solve the problems of the prior art, and therefore it is an object of the present invention to provide a dual printing mask for coating a die adhering paste on a substrate uniformly.

In order to accomplish the above object, the present invention provides a printing mask that is used for coating a paste on a substrate uniformly so as to adhere a semiconductor die to the substrate.

The printing mask according to the present invention is used for coating a paste layer of a predetermined pattern into a uniform thickness in order to adhere a semiconductor die onto a substrate, which includes a metal mask layer having a predetermined pattern of openings so as to receive a paste for adhering a semiconductor die onto a substrate; and a mesh layer integrally attached on the metal mask layer.

Preferably, the mesh layer is made of one material selected from the group consisting of nylon, polyester and stainless steel, and the metal mask layer is made of stainless steel.

Preferably, the mesh layer has meshes whose size is smaller than that of the openings. In addition, the meshes of the mesh layer preferably have lateral and vertical lengths of 25 to 2000 μm.

### BRIEF DESCRIPTION OF THE DRAWINGS

Other objects and aspects of the present invention will become apparent from the following description of embodiments with reference to the accompanying drawing in which:

FIG. 1 is schematic view showing a conventional screen printing device and a convention screen printing method;

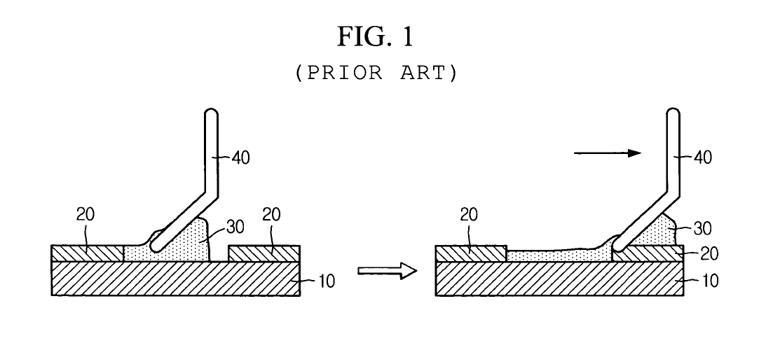

FIG. 2 is an exploded perspective view schematically showing a dual printing mask according to a preferred embodiment of the present invention; and

FIG. 3 is a schematic view illustrating a screen printing method using the dual printing mask according to the preferred embodiment of the present invention.

### DESCRIPTION OF THE PREFERRED EMBODIMENT

Hereinafter, preferred embodiments of the present invention will be described in detail referring to the accompanying drawings. Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

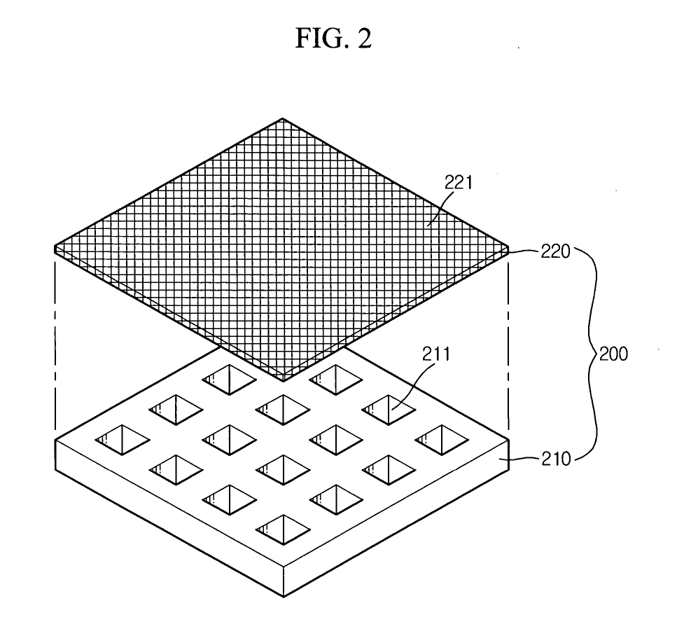

FIG. 2 is an exploded perspective view showing configuration and shape of a printing mask according to a preferred embodiment of the present invention.

Referring to FIG. 2, the dual printing mask 200 of the present invention includes a metal mask layer 210 having a predetermined pattern and a mesh layer 220 integrally attached onto the metal mask layer 210.

The metal mask layer 210 is arranged on a substrate as a printing mask for coating a paste on the substrate uniformly. In addition, a predetermined pattern of openings 211 is formed in the metal mask layer 210, and the paste is filled in the pattern of openings 211 so that a paste layer of a predetermined pattern for adhering a semiconductor die is formed on the substrate. This metal mask layer 210 is made of metal material such as stainless steel. Meanwhile, in this embodiment, the pattern of openings 211 formed in the metal mask layer 210 is shown as a rectangular shape, but the present invention is not limited thereto, and various shapes such as triangle, polygons, circle or formless shapes may be applied.

The mesh layer 220 is attached to an upper surface of the metal mask layer 210 and prevents direct contact between the squeegee and the metal mask layer 220 during the paste coating process. Thus, while the paste on the metal mask layer 220 is pressed and printed using the squeegee, pressing or looping of the paste caused by the pressure of squeegee is reduced.

The mesh layer 220 is made of nylon, polyester or stainless steel yarn, and a plurality of meshes 221 are formed therein so that the paste passes through the meshes 221 of the mesh layer 220 and is received in the pattern of openings 211 formed in the metal mask layer 210 below the mesh layer 220. Thus, the meshes 221 formed in the mesh layer 220 should have a greatly smaller size than the openings 211 formed in the metal mask layer 210, and the meshes 221 formed in the mesh layer 220 preferably have lateral or vertical lengths of 25 to 2000 μm, respectively.

The meshes 221 formed in the mesh layer 220 define their shapes in a way that fine yarns made of nylon, polyester or stainless steel are weaved into several hundred meshes.

In the present invention, the printing mask is formed integrally by fixing the mesh layer to the metal mask layer as shown in FIG. 2. At this time, the mesh layer is attached to the metal mask layer by means of adhesion using an adhesive.

Now, a screen printing process for coating a paste on a substrate using the printing mask manufactured according to the present invention will be described.

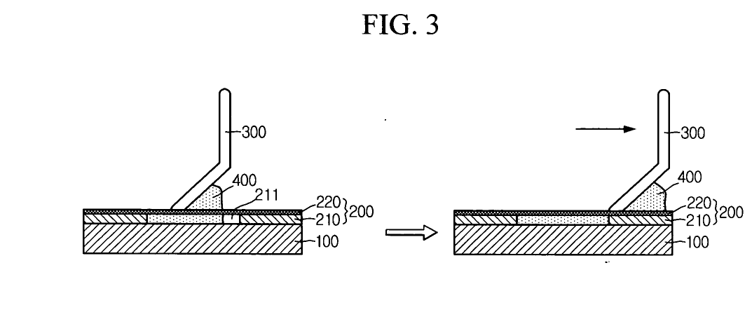

FIG. 3 is a schematic view showing a screen printing method and a device for implementing the method partially.

First, a substrate 100 to be printed is prepared, and a dual printing mask 200 is arranged on an upper surface of the substrate 100. At this time, the printing mask 200 is configured such that a metal mask layer 210 having a predetermined pattern of openings 211 formed therein is contacted with the substrate 100, and a mesh layer 220 is formed on an upper surface of the metal mask layer 210. If the substrate 100 to be printed and the dual printing mask 200 are set as mentioned above, a squeegee 300 is arranged at one side thereof.

Then, a paste 400 is applied on the dual printing mask 200, and the squeegee 300 is moved to be adhered thereto in one direction so that the paste 400 is uniformly coated on the dual printing mask 200. The squeegee 300 presses and moves the paste 400 on the dual printing mask 200 so that the paste 400 is uniformly flowed into the dual printing mask 200, namely into the mesh layer 220 and the metal mask layer 210, thereby filling the openings 211 of the metal mask layer 210. Accordingly, a paste layer corresponding to the pattern of openings 211 is formed on the substrate 100.

In the present invention, the mesh layer 220 is provided to the upper surface of the metal mask layer 210 so as to prevent direct contact between the squeegee 300 and the paste 400. In addition, meshes 221 of the mesh layers 220 having a relatively smaller size are arranged on the pattern of openings 211 formed in the metal mask layer 210 so as to prevent the squeegee 300 from being depressed into the openings 211 during movement. In addition, it is prevented that the paste 400 is moved up along the movement of the squeegee 300 at a border portion between the openings and the other areas. Thus, the paste 400 is firstly flowed into the meshes formed in the mesh layer 220 and then filled into the pattern of openings 211 of the metal mask layer 210, thereby allowing to print a paste layer 400 with a uniform thickness on the substrate 100.

In addition, if the paste 400 is printed on the substrate 100 as mentioned above, a semiconductor die is placed on its upper surface, and the semiconductor die may be adhered to the substrate 100 by pressing. At this time, if a pressure of pressing the die is excessively high, the paste may flow down at a portion where the coated paste has a great thickness. On the while, if the pressure for pressing the die is insufficient, a gap may occur at a portion where the coasted paste has a small thickness. However, the present invention solves such problems by minimizing a deviation of thickness of the paste to be coated.

Hereinafter, effects of the present invention will be explained by comparing more detailed embodiments with comparative examples.

In the embodiments and the comparative examples, a paste was coated on a substrate by means of a screen printing method using a printing mask composed of a metal mask layer according to the prior art and also a screen printing method using the dual printing mask in which the mesh layer and the metal mask layer are coupled according to the present invention. In addition, in the screen printing method using the dual printing mask, a size of meshes formed in the mesh layer was changed.

Table 1 shows kinds and features of printing masks used in the embodiments and the comparative examples.

TABLE 1

| | |
|---|---|
| Metal mask layer | Mesh layer |

| | | Lateral/vertical | | Lateral/vertical |
|---|---|---|---|---|
| | Use or | lengths of | Use or | lengths of |
| | not | openings (mm) | not | meshes (μm) |
| Embodiment 1 | Use | 5/10 | Use | 100 |
| Embodiment 2 | Use | 5/10 | Use | 500 |
| Comparative | Use | 5/10 | Not use | — |
| example 1 | | | | |
| Comparative | Use | 5/10 | Use | 20 |
| example 2 | | | | |
| Comparative | Use | 5/10 | Use | 2500 |
| example 3 | | | | |

### Embodiment 1

A dual printing mask provided with a metal mask layer and a mesh layer was arranged on a substrate, and a paste was coated thereon in one direction using a squeegee. At this time, openings formed in the metal mask layer had lateral/vertical lengths of 5/10 mm, respectively, and meshes formed in the mesh layer had lateral or vertical length of 100 μm.

### Embodiment 2

A dual printing mask provided with a metal mask layer and a mesh layer was arranged on a substrate, and a paste was coated thereon in one direction using a squeegee. At this time, openings formed in the metal mask layer had lateral/vertical lengths of 5/10 mm, respectively, and meshes formed in the mesh layer had lateral or vertical length of 500 μm.

### COMPARATIVE EXAMPLE 1

A printing mask provided with a metal mask layer was arranged on a substrate, and a paste was coated thereon in one direction using a squeegee. At this time, a pattern of openings formed in the metal mask layer had lateral/vertical lengths of 5/10 mm, respectively.

### COMPARATIVE EXAMPLE 2

A dual printing mask provided with a metal mask layer and a mesh layer was arranged on a substrate, and a paste was coated thereon in one direction using a squeegee. At this time, openings formed in the metal mask layer had lateral/vertical lengths of 5/10 mm, respectively, and meshes formed in the mesh layer had lateral or vertical length of 20 μm.

### COMPARATIVE EXAMPLE 3

A dual printing mask provided with a metal mask layer and a mesh layer was arranged on a substrate, and a paste was coated thereon in one direction using a squeegee. At this time, openings formed in the metal mask layer had lateral/vertical lengths of 5/10 mm, respectively, and meshes formed in the mesh layer had lateral or vertical length of 2500 μm.

Meanwhile, in order to check results of the embodiments and the comparative examples, the following features were measured.

1. Measurement of Thickness

A thickness at a center portion of the paste coated on the printed circuit substrate was measured using an Alpha step.

2. Deviation of Thickness

A deviation of thickness of the paste coated on the printed circuit substrate was measured using an Alpha step.
Deviation of thickness=A/B×100%

Here, A is a value obtained by deducting an average thickness of the coated paste from a greatest thickness of the coated paste, and B is the thickness at the center portion of the paste coated on one surface of the printed circuit substrate.

3. Die Adhesion Features

A pressure of 0.8 Mpa was applied at 120° C. for 1.5 second to adhere a die, and shear strength of the adhered die was measured. Here, it is determined as success if the shear strength was over 0.5 Kgf/□5 mm×5 mm chip.

4. MRT (Moisture Resistance Test)

A presence of crack and pop-corn phenomenon was checked when a semiconductor package was kept for one day at 85° C., 85% in a constant-temperature and constant-humidity state and then IR flow (i.e., heating using an IR radiation) was conducted thereto at a high temperature of 260° C. at the maximum (or, under the Pb-free condition designated by Jedec), thereby evaluating reliability of the semiconductor package.

Table 2 shows test results for the features, conducted after paste layers were formed on substrates according to the embodiments and the comparative examples.

TABLE 2

| | Thickness at center | | | |
|---|---|---|---|---|
| | portion of paste layer | Surface state | Presence of void | |
| | (μm) | of paste layer | in adhering die | MRT |
| Embodiment 1 | 70 | Good | None | Success |
| Embodiment 2 | 80 | Good | None | Success |
| Comparative | 82 | Thick in one | Presence | Failure |
| example 1 | | side | | |
| Comparative | 30 | Small bubbles | None | Success |
| example 2 | | generated | | |
| Comparative | 82 | Great bubbles | Presence | Failure |
| example 3 | | generated | | |

Seeing Table 2, in case of coating a paste by the screen printing method using only the metal mask as in the comparative example 1, the coated paste had a deviation of thickness of 40%, where the paste was not uniform but thicker in one side, generated voids due to the deviation of thickness when the same pressure was applied during the die adhering process, and also showed problems in evaluations of moisture absorption and IR reflow resistance.

In case of the comparative examples 2 and 3, when a paste was coasted using the dual printing mask provided with a metal mask layer and a mesh layer and at this time the meshes formed in the mesh layer were respectively 20 μm and 2500 μm in lateral and vertical directions, the coated paste showed deviations of difference of 10% and 15% respectively, which are lower than the case of the comparative example 1, but bubbles were generated, voids were generated during the die adhering process, and problems occurred in evaluations of moisture absorption and IR reflow resistance.

In case of the embodiments 1 and 2, when a paste was coated using the dual printing mask provided with a metal mask layer and a mesh layer and at this time the meshes formed in the mesh layer were respectively 100 μm and 500 μm in lateral and vertical directions, the coated paste showed deviations of difference of 10% in both cases, which is greatly lower. In addition, it showed no problems in surface state of the coated paste, a presence of void during the die adhering process, evaluations of moisture absorption and IR reflow resistance.

It could be understood from the test results of the embodiments and the comparative examples that, when a die adhering paste is coated on a printed circuit substrate, a screen printing method using a dual printing mask composed of a metal mask layer and a mesh layer is effective, and it is preferred that the meshes formed in the mesh layer used herein have lateral or vertical length of 25 to 2000 μm.

As described above, the present invention has been described in detail referring to the accompanying drawings. However, it should be understood that the detailed description and specific embodiments of the invention are given by way of illustration only, not intended to limit the scope of the invention, since various changes and modifications within the spirit and scope of the invention will become apparent to those skilled in the art from this detailed description, so it should be understood that other equivalents and modifications within the spirit and scope of the invention will become apparent to those skilled in the art from this detailed description.

### APPLICABILITY TO THE INDUSTRY

The present invention coats a die adhering paste by the screen printing method using a dual printing mask provided with a mesh layer and a metal mask layer, so it may control a deviation of thickness of a coated paste below about 20%. In addition, the present invention may improve reliability of semiconductor packaging products by restraining melt flow or void generated due to different pressures applied during the die adhering process.

What is claimed is:

1. A printing mask for coating a paste layer of a predetermined pattern into a uniform thickness in order to adhere a semiconductor die onto a substrate, the printing mask comprising:
a metal mask layer having a predetermined pattern of openings so as to receive a paste for adhering a semiconductor die onto a substrate; and
a mesh layer integrally attached on the metal mask layer.

2. The printing mask according to claim 1,
wherein the mesh layer has meshes whose size is smaller than that of the openings.

3. The printing mask according to claim 1,
wherein the mesh layer is made of one material selected from the group consisting of nylon, polyester and stainless steel.

4. The printing mask according to claim 1,
wherein the metal mask layer is made of stainless steel.

5. The printing mask according to claim 2,
wherein the meshes of the mesh layer have lateral and vertical lengths of 25 to 2000 μm.
